(19) United States
(12) Patent Application Publication
(10) Pub. No.: US 2010/0295840 A1
(43) Pub. Date: Nov. 25, 2010

(54) LIQUID CRYSTAL DISPLAY APPARATUS AND BACKLIGHT DEVICE

(75) Inventors: Takashi Uno, Osaka (JP); Hirofumi Shimizu, Osaka (JP)

Correspondence Address: GREENBLUM & BERNSTEIN, P.L.C., 1950 ROLAND CLARKE PLACE, RESTON, VA, 20191, US

(73) Assignee: PANASONIC CORPORATION, Osaka (JP)

(21) Appl. No.: 12/863,224

(22) PCT Filed: Jan. 27, 2009
(86) PCT No.: PCT/JP2009/000311

§ 371 Date: Jul. 16, 2010

(30) Foreign Application Priority Data
Feb. 1, 2008 (JP) 2008-022770

(51) Int. Cl. G09G 5/00; G09G 3/36

(52) U.S. Cl. 345/212; 345/102

(57) ABSTRACT

When a power supply switch is turned on, a signal generation circuit generates a starting video signal for an all-white display for a given period of time. A selector outputs the starting video signal generated by the signal generation circuit to a liquid crystal display panel drive circuit. This causes the all-white display to be performed on a screen of a liquid crystal display panel for the given period of time. A lighting voltage is applied to a fluorescent lamp of a backlight unit by an inverter power supply circuit at a given timing in the given period of time.

### TECHNICAL FIELD

The present invention relates to a liquid crystal display apparatus including a liquid crystal display panel and a backlight device.

### BACKGROUND ART

A liquid crystal display apparatus includes a liquid crystal display panel that displays images, and a backlight device arranged at the back of the liquid crystal display panel.

The backlight device includes a plurality of fluorescent lamps, an inverter power supply circuit that applies a drive voltage to the fluorescent lamps, and a control circuit that controls the inverter power supply circuit.

Cold cathode fluorescent lamps (CCFLs) or external electrode fluorescent lamps (EEFLs) are used as the fluorescent lamps. The cold cathode fluorescent lamp has internal electrodes at both ends thereof. The external electrode fluorescent lamp has external electrodes at both ends thereof.

In the backlight device, a power supply switch is turned on to cause a high voltage to be applied to the lamp electrodes. This causes the fluorescent lamps to be lit.

When the liquid crystal display apparatus is left in a dark place for a long period of time, lighting performance (starting performance) of the fluorescent lamps of the backlight device is degraded to inhibit the fluorescent lamps from starting in some cases. Such a phenomenon is generally called a darkness problem.

Therefore, an emitter substance such as cesium that easily emit free electrons is applied to the electrodes of the fluorescent lamps, or the emitter substance is mixed in a fluorescent substance.

Providing a control circuit that attempts restart of the fluorescent lamps in the case of failure to start the fluorescent lamps has been suggested (see Patent Document 1).

Furthermore, arranging an auxiliary light source such as an LED (Light Emitting Diode) or a tungsten lamp near the fluorescent lamps has been suggested (see Patent Document 2). In this case, the auxiliary light source is lit at the time of starting the fluorescent lamps to excite photoelectrons, thereby improving the lighting performance of the fluorescent lamps.

[Patent Document 1] JP 6-33399 U

[Patent Document 2] JP 4-6522 A

### DISCLOSURE OF THE INVENTION

### Problems to be Solved by the Invention

In the method of using the emitter substance, however, lighting the fluorescent lamps for a long period of time causes the emitter substance in the fluorescent lamps to evaporate, for example, resulting in exhaustion. This may degrade the starting performance of the fluorescent lamps.

In the method of attempting restart of the fluorescent lamps in the case of failure to start the fluorescent lamps, a longer period of time is required for lighting the backlight device. When lighting the backlight device takes several tens of seconds to several minutes, a user judges that a failure has occurred in the backlight device.

The method of using the auxiliary light source allows for comparatively reliable lighting. However, this method leads to a complicated structure of the backlight device, resulting in increased cost of the backlight.

An object of the present invention is to provide a backlight device capable of improving the starting characteristics of the fluorescent lamps with a simple structure and a liquid crystal display apparatus including the same.

### Means for Solving the Problems

(1) According to an aspect of the present invention, a backlight device that is provided at a liquid crystal display panel includes a fluorescent lamp arranged on a back side of the liquid crystal display panel, a display controller that performs a starting display, whose whole or partial portion has a region that is not black, on a screen of the liquid crystal display panel for a certain period of time from the time when a power supply switch is turned on, and a voltage application unit that applies a lighting voltage to the fluorescent lamp after a given period of time from the time when the power supply switch is turned on.

In the backlight device, the starting display, whose whole or partial portion has the region that is not black, is performed on the screen of the liquid crystal display panel by the display controller for the certain period of time from the time when the power supply switch is turned on. This causes external light to pass through liquid crystals of the liquid crystal display panel to enter the fluorescent lamp. In this case, photoelectrons are generated within the fluorescent lamp. This improves starting characteristics of the fluorescent lamp.

As a result, when the lighting voltage is applied to the fluorescent lamp by the voltage application unit after the given period of time from the time when the power supply switch is turned on, the fluorescent lamp is lit in a short period of time.

In this manner, the starting characteristics of the fluorescent lamp can be improved with a simple structure.

(2) The starting display may be a display whose whole portion is white.

In this case, the external light passes through the liquid crystals of the liquid crystal display panel to sufficiently enter the fluorescent lamp at the time of starting the fluorescent lamp. This sufficiently improves the starting characteristics of the fluorescent lamp.

(3) The starting display may be a display having a white pattern.

In this case, the fluorescent lamp can be lit in a short period of time without giving any uncomfortable feeling to a user.

(4) The voltage application unit may apply the lighting voltage to the fluorescent lamp at a given timing in a period of time where the starting display is performed by the display controller.

In this case, the photoelectrons are generated within the fluorescent lamp before and after the timing at which the lighting voltage is applied to the fluorescent lamp. Accordingly, the fluorescent lamp can be reliably lit.

(5) The display controller may perform the starting display on the screen of the liquid crystal display panel for a first period of time from the time when the power supply switch is turned on, and subsequently perform a display of black on the screen of the liquid crystal display panel for a second period of time.

In this case, black, not white, is displayed on the whole screen when the fluorescent lamp is lit. This prevents a user from suffering from glare when the fluorescent lamp is lit or from judging that a failure is occurring in the liquid crystal display apparatus.

(6) The display controller may perform the starting display on the screen of the liquid crystal display panel for a first period of time from the time when the power supply switch is turned on, and subsequently perform a display having a white pattern on the screen of the liquid crystal display panel for a second period of time.

In this case, the photoelectrons are generated within the fluorescent lamp before and after the timing where the lighting voltage is applied to the fluorescent lamp. Accordingly, the fluorescent lamp can be reliably lit without giving any uncomfortable feeling to a user.

The display having the white pattern, not a display of white, is performed on the whole screen when the fluorescent lamp is lit. This prevents a user from suffering from glare when the fluorescent lamp is lit or from judging that a failure is occurring in the liquid crystal display apparatus.

(7) The display controller may perform the starting display and a display of black on the screen of the liquid crystal display panel from the time when the power supply switch is turned on, and subsequently repeat the starting display and the display of black a given number of times when the fluorescent lamp is not lit.

In this case, the fluorescent lamp can be reliably lit.

(8) The display controller may perform the starting display and a display having a white pattern on the screen of the liquid crystal display panel from the time when the power supply switch is turned on, and subsequently repeat the starting display and the display having the white pattern a given number of times when the fluorescent lamp is not lit. In this case, the fluorescent lamp can be reliably lit.

(9) The fluorescent lamp may be an external electrode fluorescent lamp. Also in this case, the starting characteristics of the fluorescent lamp can be improved with a simple structure.

(10) According to another aspect of the present invention, a liquid crystal display apparatus includes a liquid crystal display panel, and the backlight device according to the first invention that is provided at the liquid crystal display panel.

The backlight device according to the first invention is used, so that the starting characteristics of the fluorescent lamp can be improved with a simple structure in the liquid crystal display apparatus.

### EFFECTS OF THE INVENTION

According to the present invention, the starting characteristics of the fluorescent lamp can be improved with a simple structure.

### BRIEF DESCRIPTION OF THE DRAWINGS

FIG. 1 is a block diagram showing the configuration of a liquid crystal display apparatus according to a first embodiment of the present invention.

FIG. 2 is a timing chart showing operation at the time of starting of a backlight device according to the first embodiment.

FIG. 3 is a timing chart showing operation at the time of starting of a liquid crystal display apparatus according to a second embodiment.

FIG. 4 is a schematic diagram showing one example of a display of a starting pattern.

FIG. 5 is a diagram showing a relationship between an area of white portions in the starting pattern and a starting period of time.

FIG. 6 is a timing chart showing operation at the time of starting of a liquid crystal display apparatus according to a third embodiment.

FIG. 7 is a timing chart showing operation at the time of starting of a liquid crystal display apparatus according to a fourth embodiment.

FIG. 8 is a block diagram showing the configuration of a liquid crystal display apparatus according to a fifth embodiment of the present invention.

FIG. 9 is a block diagram showing the configuration of an inverter power supply circuit in the liquid crystal display apparatus.

FIG. 10 is a timing chart showing operation at the time of starting of a liquid crystal display apparatus according to the fifth embodiment.

### BEST MODE FOR CARRYING OUT THE INVENTION

### (1) First Embodiment

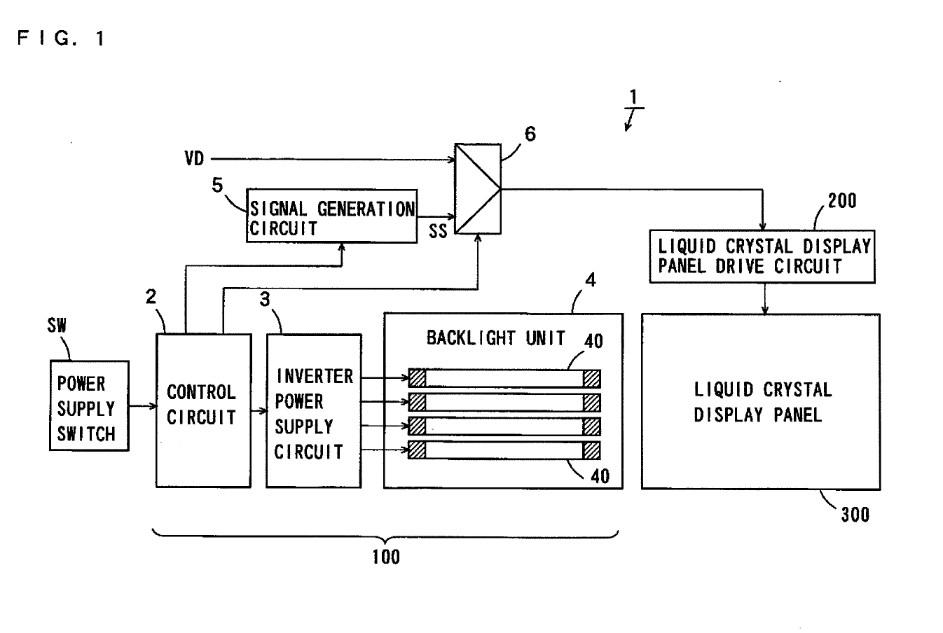

FIG. 1 is a block diagram showing the configuration of a liquid crystal display apparatus according to a first embodiment of the present invention.

The liquid crystal display apparatus 1 of FIG. 1 includes a power supply switch SW, a backlight device 100, a liquid crystal display panel drive circuit 200 and a liquid crystal display panel 300.

The backlight device 100 includes a control circuit 2, an inverter power supply circuit 3, a backlight unit 4, a signal generation circuit 5 and a selector 6.

The backlight unit 4 includes a plurality of fluorescent lamps 40, and is arranged on the back side of the liquid crystal display panel 300. The fluorescent lamps 40 are external electrode fluorescent lamps (EEFLs) or cold cathode fluorescent lamps (CCFLs). In the present embodiment, the external electrode fluorescent lamps (EEFLs) are employed as the fluorescent lamps 40.

When the power supply switch SW is turned on, the control circuit 2 controls the inverter power supply circuit 3, the signal generation circuit 5 and the selector 6. The inverter power supply circuit 3 converts an AC voltage into a DC voltage, and applies the DC voltage to the plurality of fluorescent lamps 40 of the backlight unit 4 as a lighting voltage.

The signal generation circuit 5 generates a starting video signal SS for performing a display having predetermined color and luminance on a screen of the liquid crystal display panel 300 at the time of starting the backlight unit 4 according to control by the control circuit 2. In the present embodiment, a video signal for performing a display of white on the whole screen (hereinafter referred to as an all-white display) and a video signal for performing a display of black on the whole screen (hereinafter referred to as an all-black display) are generated.

According to the control by the control circuit 2, the selector 6 selectively outputs a video signal VD that is applied after the backlight unit is started, and the starting video signal SS that is generated by the signal generation circuit 5.

The liquid crystal display panel drive circuit 200 performs a display on the screen of the liquid crystal display panel 300 based on the video signal output from the selector 6.

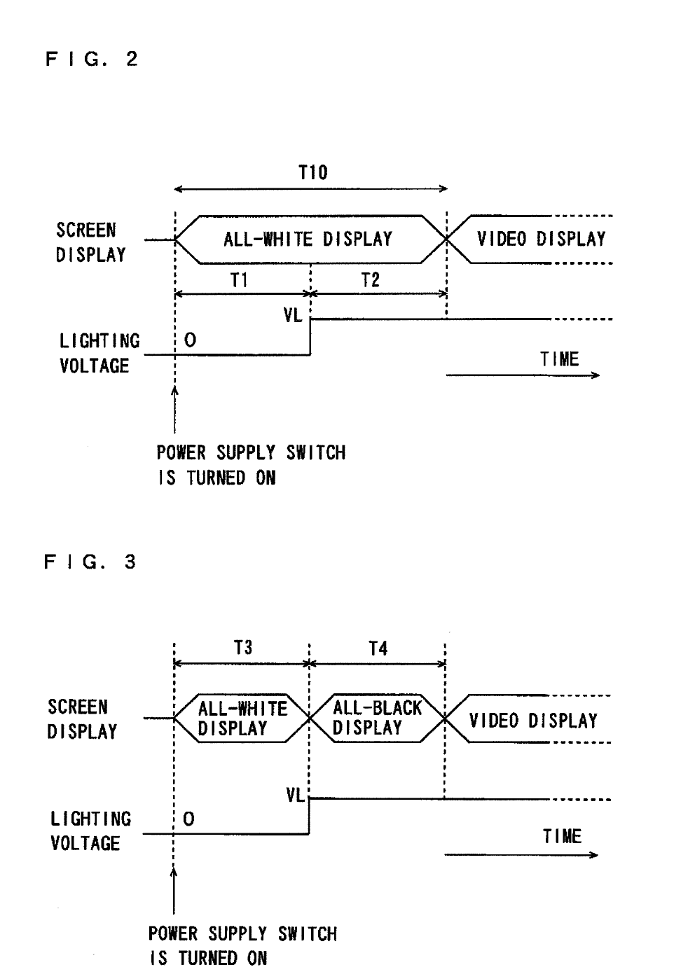

FIG. 2 is a timing chart showing operation at the time of starting of the liquid crystal display apparatus 1 according to the first embodiment.

An upper stage of FIG. 2 shows a display state of the screen of the liquid crystal display panel 300, and a lower stage shows the lighting voltage applied to the backlight unit 4 by the inverter power supply circuit 3. The abscissa of FIG. 2 indicates time.

When the power supply switch SW is turned on, the signal generation circuit 5 generates the starting video signal SS for performing the all-white display for a given period of time T10 (about two seconds, for example). The selector 6 outputs the starting video signal SS generated by the signal generation circuit 5 to the liquid crystal display panel drive circuit 200. This causes the all-white display to be performed on the screen of the liquid crystal display panel 300 for the given period of time T10.

In this case, external light passes through liquid crystals of the liquid crystal display panel 300 to enter the plurality of fluorescent lamps 40 of the backlight unit 4. This improves starting characteristics of the fluorescent lamps 40, as will be described below.

A lighting voltage VL is applied to the fluorescent lamps 40 of the backlight unit 4 by the inverter power supply circuit 3 at a given timing in the given period of time T10. In the present embodiment, after the power supply switch SW is turned on, the all-white display is performed for a period of time T1 (about one second, for example), and then the lighting voltage VL is applied to the fluorescent lamps 40 and the all-white display further continues for a period of time T2 (about one second, for example). This causes the fluorescent lamps 40 of the backlight unit 4 to be lit.

After that, the selector 6 outputs the video signal VD to the liquid crystal display panel drive circuit 200. Accordingly, video based on the video signal VD is displayed on the screen of the liquid crystal display panel 300.

Display modes of the liquid crystal display panel generally include a TN (Twisted Nematic) mode, an IPS (In-Plane Switching) mode and a VA (Vertical Alignment) mode.

In particular, the IPS mode and the VA mode are employed in a television receiver. The IPS mode and the VA mode are called a normally black mode, and perform a display of black when the television receiver is not driven, that is, when powered off. In the liquid crystal display panel, neither light generated by the backlight unit nor the external light passes through the liquid crystals when the display of black is performed. This does not cause the external light to enter the backlight unit.

Therefore, a state of the fluorescent lamps within the backlight unit with the power supply switch of the liquid crystal display apparatus turned off for a long period of time equals to a state of the fluorescent lamps left in a dark place for a long period of time, even though surroundings are lighted. This results in lower starting performance from darkness.

In the liquid crystal display apparatus 1 according to the present embodiment, the all-white display is performed on the screen of the liquid crystal display apparatus 1 when the power supply switch SW is turned on, as described above. This causes the external light to pass through the liquid crystals of the liquid crystal display panel 300 to enter the plurality of fluorescent lamps 40 of the backlight unit 4. In this case, photoelectrons are generated within the fluorescent lamps 40. As a result, the starting characteristics of the fluorescent lamps 40 are improved, and the fluorescent lamps 40 are lit in a short period of time.

### (2) Second Embodiment

A liquid crystal display apparatus according to a second embodiment has the same structure as the liquid crystal display apparatus 1 shown in FIG. 1. The liquid crystal display apparatus according to the second embodiment is different from the liquid crystal display apparatus according to the first embodiment in the following points.

FIG. 3 is a timing chart showing operation at the time of starting of the liquid crystal display apparatus 1 according to the second embodiment.

An upper stage of FIG. 3 shows a display state of the screen of the liquid crystal display panel 300, and a lower stage shows the lighting voltage applied to the backlight unit 4 by the inverter power supply circuit 3. The abscissa of FIG. 3 indicates time.

When the power supply switch SW is turned on, the signal generation circuit 5 generates the starting video signal SS for performing the all-white display for a period of time T3 (about one second, for example). The selector 6 outputs the starting video signal SS generated by the signal generation circuit 5 to the liquid crystal display panel drive circuit 200. This causes the all-white display to be performed on the screen of the liquid crystal display panel 300 for the period of time T3.

In this case, the external light passes through the liquid crystals of the liquid crystal display panel 300 to enter the plurality of fluorescent lamps 40 of the backlight unit 4. This improves the starting characteristics of the fluorescent lamps 40.

Then, the signal generation circuit 5 generates the starting video signal SS for performing the all-black display for a period of time T4 (about one second, for example). The selector 6 outputs the starting video signal SS generated by the signal generation circuit 5 to the liquid crystal display panel drive circuit 200. This causes the all-black display to be performed on the screen of the liquid crystal display panel 300 for the period of time T4.

The lighting voltage VL is applied to the fluorescent lamps 40 of the backlight unit 4 by the inverter power supply circuit 3 simultaneously with switching of the all-white display to the all-black display.

Here, a fluorescent substance of the fluorescent lamps 40 has a light storage effect. Therefore, even though the external light does not enter the backlight unit 4 at the time of or immediately before the application of the lighting voltage VL to the fluorescent lamps 40, the starting characteristics is improved by the photoelectrons stored in the fluorescent substance of the fluorescent lamps 40 because of the light storage effect. This causes the fluorescent lamps 40 of the backlight unit 4 to be immediately lit.

Then, the selector 6 outputs the video signal VD to the liquid crystal display panel drive circuit 200. Accordingly, video based on the video signal VD is displayed on the screen of the liquid crystal display panel 300.

In the present embodiment, black, not white, is displayed on the whole screen when the fluorescent lamps 40 are lit. This prevents a user from suffering from glare when the fluorescent lamps 40 are lit or from judging that a failure is occurring in the liquid crystal display apparatus 1.

### (3) Third Embodiment

A liquid crystal display apparatus according to a third embodiment has the same structure as the liquid crystal display apparatus 1 shown in FIG. 1. The liquid crystal display apparatus according to the third embodiment is different from the liquid crystal display apparatus according to the first embodiment in the following points.

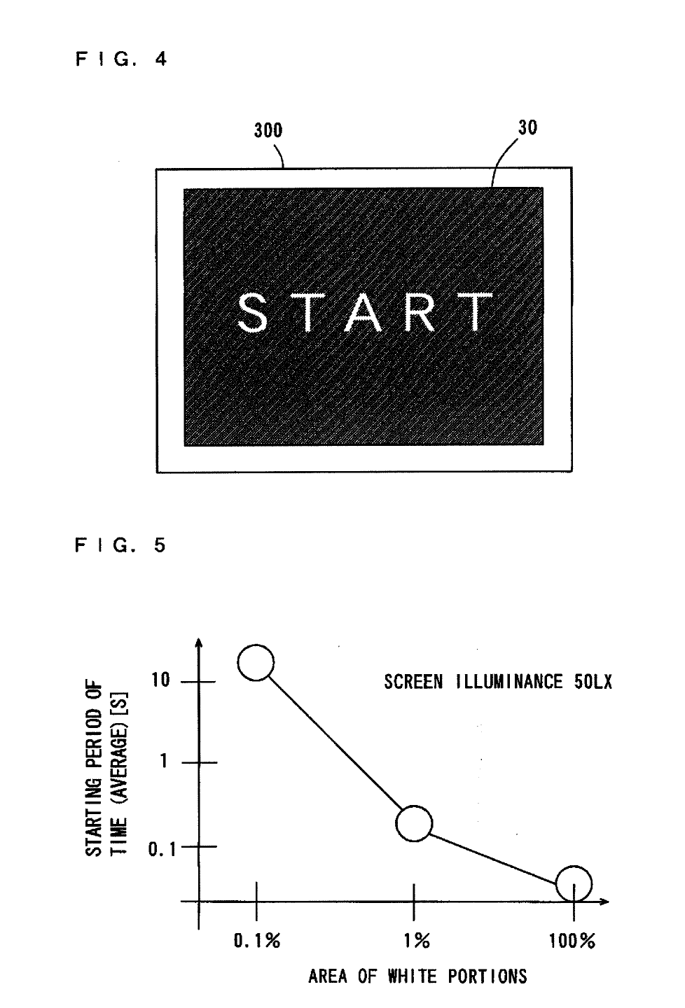

The signal generation circuit 5 generates a starting pattern when the backlight device 100 is started. FIG. 4 is a schematic diagram showing one example of a display of the starting pattern.

In FIG. 4, the display of the starting pattern is performed on the screen 30 of the liquid crystal display panel 300. The starting pattern has white characters or pictures in a background of black, for example.

FIG. 5 is a diagram showing a relationship between an area of white portions in the starting pattern and a starting period of time. The abscissa of FIG. 5 indicates a ratio of the area of the white portions to an area of the whole starting pattern, and the ordinate indicates the starting period of time of the fluorescent lamps 40 of the backlight unit 4. Illuminance of the screen is 50 lux.

As shown in FIG. 5, the starting period of time of the fluorescent lamps 40 becomes shorter as the ratio of the area of the white portions in the starting pattern is increased.

When the ratio of the area of the white portions in the starting pattern is 1% or more, the starting period of time can be much shorter than one second. Accordingly, the ratio of the area of the white portions in the starting pattern is preferably 1% or more.

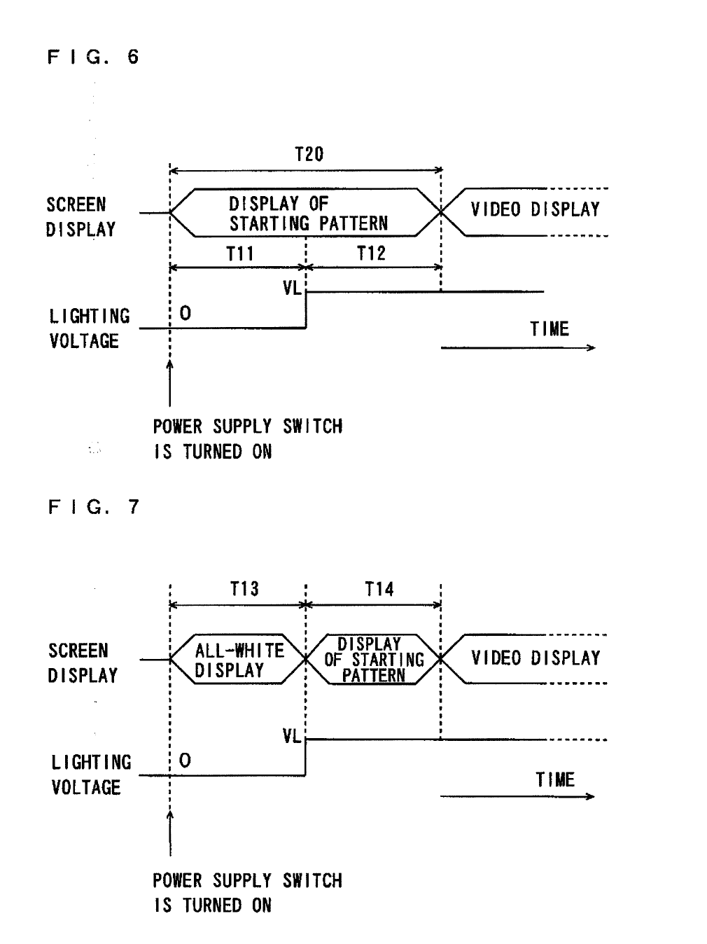

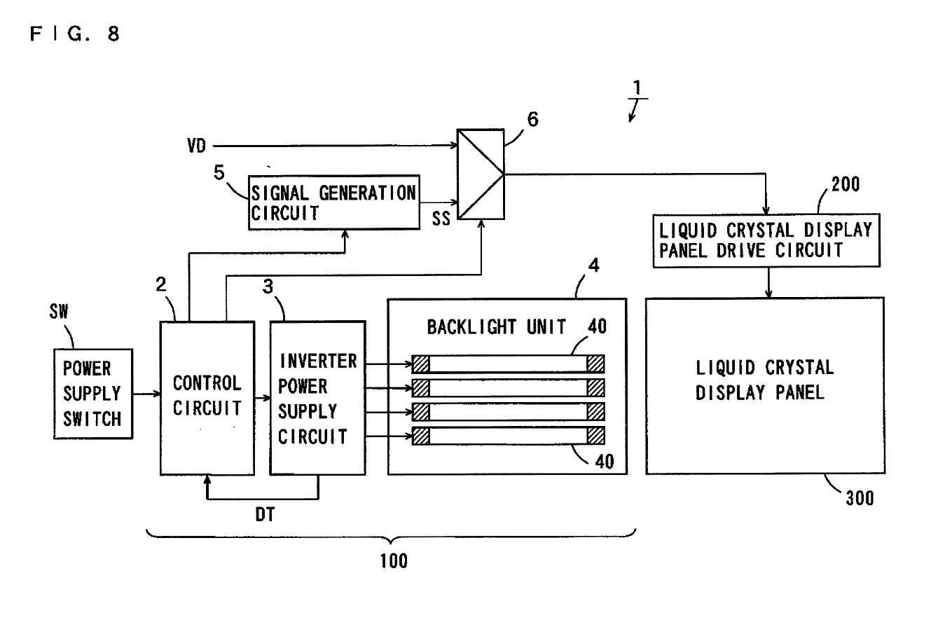

FIG. 6 is a timing chart showing operation at the time of starting of the liquid crystal display apparatus according to the third embodiment.

An upper stage of FIG. 6 shows a display state of the screen of the liquid crystal display panel 300, and a lower stage shows the lighting voltage applied to the backlight unit 4 by the inverter power supply circuit 3. The abscissa of FIG. 6 indicates time.

When the power supply switch SW is turned on, the signal generation circuit 5 generates the starting video signal SS for performing the display of the starting pattern at a given timing in a given period of time T20 (about two seconds, for example). The selector 6 outputs the starting video signal SS generated by the signal generation circuit 5 to the liquid crystal display panel drive circuit 200. Thus, the display of the starting pattern is performed on the screen of the liquid crystal display panel 300 for the given period of time T20.

In this case, the external light passes through the liquid crystals of the liquid crystal display panel 300 to enter the plurality of fluorescent lamps 40 of the backlight unit 4. This improves the starting characteristics of the fluorescent lamps 40. The inverter power supply circuit 3 applies the lighting voltage VL to the fluorescent lamps 40 of the backlight unit 4 for the given period of time T20. In the present embodiment, after the power supply switch SW is turned on, the display of the starting pattern is performed for a period of time T11 (about one second, for example), and then the lighting voltage VL is applied to the fluorescent lamps 40 and the display of the starting pattern further continues for a period of time T12 (about one second, for example). This causes the fluorescent lamps 40 of the backlight unit 4 to be lit.

After that, the selector 6 outputs the video signal VD to the liquid crystal display panel drive circuit 200. Accordingly, video based on the video signal VD is displayed on the screen of the liquid crystal display panel 300.

In the liquid crystal display apparatus 1 according to the present embodiment, the display of the starting pattern having characters or pictures is performed on the screen of the liquid crystal display panel 300 at the time of starting the backlight device 100. Accordingly, the fluorescent lamps 40 of the backlight unit 4 can be lit in a short period of time without giving any uncomfortable feeling to a user.

### (4) Fourth Embodiment

A liquid crystal display apparatus according to a fourth embodiment has the same structure as the liquid crystal display apparatus 1 shown in FIG. 1. The liquid crystal display apparatus according to the fourth embodiment is different from the liquid crystal display apparatus according to the second embodiment in the following points.

FIG. 7 is a timing chart showing operation at the time of starting of the liquid crystal display apparatus 1 according to the fourth embodiment.

An upper stage of FIG. 7 shows a display state of the screen of the liquid crystal display panel 300, and a lower stage shows the lighting voltage applied to the backlight unit 4 by the inverter power supply circuit 3. The abscissa of FIG. 7 indicates time.

When the power supply switch SW is turned on, the signal generation circuit 5 generates the starting video signal SS for performing the all-white display for a period of time T13 (about one second, for example). The selector 6 outputs the starting video signal SS generated by the signal generation circuit 5 to the liquid crystal display panel drive circuit 200. Thus, the all-white display is performed on the screen of the liquid crystal display panel 300 for the period of time T13.

In this case, the external light passes through the liquid crystals of the liquid crystal display panel 300 to enter the plurality of fluorescent lamps 40 of the backlight unit 4. This improves the starting characteristics of the fluorescent lamps 40.

Then, the signal generation circuit 5 generates the starting video signal SS for performing the display of the starting pattern for a period of time T14 (about one second, for example). The selector 6 outputs the starting video signal SS generated by the signal generation circuit 5 to the liquid crystal display panel drive circuit 200. This causes the display of the starting pattern to be performed on the screen of the liquid crystal display panel 300 for the period of time T14.

The lighting voltage VL is applied to the fluorescent lamps 40 of the backlight unit 4 by the inverter power supply circuit 3 simultaneously with switching of the all-white display to the display of the starting pattern.

In this case, the external light enters the backlight unit 4 through the liquid crystals of the liquid crystal display panel 300 also in a period of time where the display of the starting pattern is performed. This further improves the starting characteristics of the fluorescent lamps 40 of the backlight unit 4.

Then, the selector 6 outputs the video signal VD to the liquid crystal display panel drive circuit 200. Accordingly, video based on the video signal VD is displayed on the screen of the liquid crystal display panel 300.

In the present embodiment, the starting pattern having the characters or pictures, not white, is displayed on the whole screen when the fluorescent lamps 40 are lit. This prevents a user from suffering from glare when the fluorescent lamps 40 are lit or from judging that a failure is occurring in the liquid crystal display apparatus 1.

### (5) Fifth Embodiment

FIG. 8 is a block diagram showing the configuration of a liquid crystal display apparatus according to a fifth embodiment of the present invention.

The liquid crystal display apparatus 1 of FIG. 8 is different from the liquid crystal display apparatus 1 of FIG. 1 in the following points. The inverter power supply circuit 3 applies a non-lit detecting signal DT to the control circuit 2 when the fluorescent lamps 40 of the backlight unit 4 are not lit after a given period of time from the application of the lighting voltage VL to the fluorescent lamps 40.

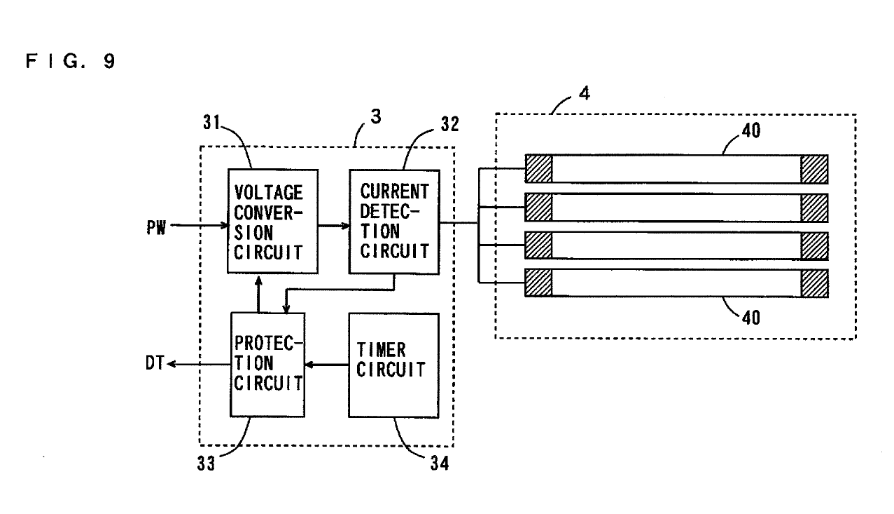

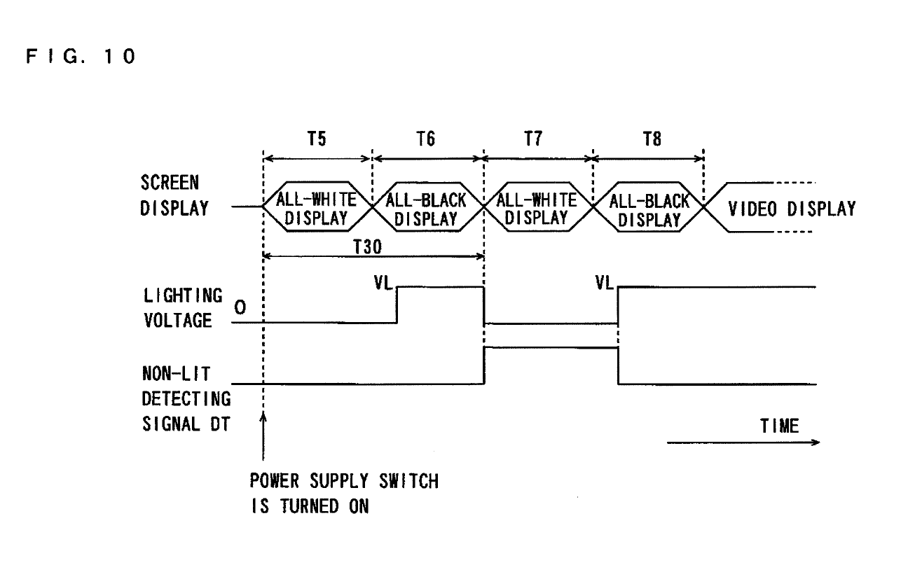

FIG. 9 is a block diagram showing the configuration of the inverter power supply circuit 3 in the liquid crystal display apparatus 1.

The inverter power supply circuit 3 includes a voltage conversion circuit 31, a current detection circuit 32, a protection circuit 33 and a timer circuit 34.

The voltage conversion circuit 31 converts the AC voltage PW supplied from a commercial power supply into the DC lighting voltage, and applies the DC lighting voltage to the fluorescent lamps 40 of the backlight unit 4 through the current detection circuit 32. The current detection circuit 32 detects a current flowing through the fluorescent lamps 40, and outputs a detected value.

The timer circuit 34 measures a period of time elapsed since the power supply switch SW is turned on, and applies an ON signal to the protection circuit 33 when a measured value reaches a given period of time (two seconds, for example). Operation of the protection circuit 33 is inhibited until the ON signal is applied from the timer circuit 34.

The protection circuit 33 is operated when the ON signal is applied from the timer circuit 34. When the detected value of the current detection circuit 32 is not more than a given value, that is, when the current flowing through the fluorescent lamps 40 is not more than the given value, the protection circuit 33 stops operation of the voltage conversion circuit 31 and outputs the non-lit detecting signal DT.

The voltage output from the voltage conversion circuit 31 is as high as about 1 kV. Therefore, the protection circuit 33 operates to stop the operation of the voltage conversion circuit 31 in order to inhibit smoking or ignition from occurring in the case of disconnection of connecting wires to the fluorescent lamps 40, for example.

FIG. 10 is a timing chart showing operation at the time of starting of the backlight device 100 according to the fifth embodiment.

An upper stage of FIG. 10 shows a display state of the screen of the liquid crystal display panel 300, an intermediate stage shows the lighting voltage applied to the backlight unit 4 by the inverter power supply circuit 3, and a lower stage shows the non-lit detecting signal DT output from the inverter power supply circuit 3. The abscissa of FIG. 10 indicates time.

When the power supply switch SW is turned on, the signal generation circuit 5 generates the starting video signal SS for performing the all-white display for a period of time T5 (about one second, for example). The selector 6 outputs the starting video signal SS generated by the signal generation circuit 5 to the liquid crystal display panel drive circuit 200. This causes the all-white display to be performed on the screen of the liquid crystal display panel 300 for the period of time T5.

In this case, the external light passes through the liquid crystals of the liquid crystal display panel 300 to enter the plurality of fluorescent lamps 40 of the backlight unit 4. This improves the starting characteristics of the fluorescent lamps 40.

Then, the signal generation circuit 5 generates the starting video signal SS for performing the all-black display for a period of time T6 (about one second, for example). The selector 6 outputs the starting video signal SS generated by the signal generation circuit 5 to the liquid crystal display panel drive circuit 200. This causes the all-black display to be performed on the screen of the liquid crystal display panel 300 for the period of time T6.

After the all-white display is switched to the all-black display, the inverter power supply circuit 3 applies the lighting voltage VL to the fluorescent lamps 40 of the backlight unit 4.

The protection circuit 33 of FIG. 9 is operated after a given period of time T30 (two seconds, for example) has elapsed since the power supply switch SW is turned on. At this time, when the fluorescent lamps 40 are not lit, the operation of the voltage conversion circuit 31 of FIG. 9 is stopped, and the non-lit detecting signal DT output by the protection circuit 33 rises to a high level. This causes the output voltage from the voltage conversion circuit 31 to attain zero.

Accordingly, the signal generation circuit 5 generates the starting video signal SS for performing the all-white display for a period of time T7 (about one second, for example). The selector 6 outputs the starting video signal SS generated by the signal generation circuit 5 to the liquid crystal display panel drive circuit 200. This causes the all-white display to be performed on the screen of the liquid crystal display panel 300 for the period of time T7.

The signal generation circuit 5 subsequently generates the starting video signal SS for performing the all-black display for a period of time T8 (about one second, for example). The selector 6 outputs the starting video signal SS generated by the signal generation circuit 5 to the liquid crystal display panel drive circuit 200. This causes the all-black display to be performed on the screen of the liquid crystal display panel 300 for the period of time T8.

After the all-white display is switched to the all-black display, the inverter power supply circuit 3 again applies the lighting voltage VL to the fluorescent lamps 40 of the backlight unit 4. This causes the fluorescent lamps 40 of the backlight unit 4 to be lit. At the same time, the non-lit detecting signal DT output by the protection circuit 33 falls to a low level.

Then, the selector 6 outputs the video signal VD to the liquid crystal display panel drive circuit 200. Accordingly, video based on the video signal VD is displayed on the screen of the liquid crystal display panel 300.

In the liquid crystal display apparatus 1 according to the present embodiment, the all-white display is again performed in the case of failure to start the fluorescent lamps 40 of the backlight unit 4 by the application of the lighting voltage VL. This allows the fluorescent lamps 40 to be reliably lit.

### (6) Other Embodiments

A temperature sensor that measures the temperature of the backlight unit 4 may be provided in the liquid crystal display apparatuses 1 according to the first to fifth embodiments. Here, at the time of starting the backlight unit 4, the all-white display or the display of the starting pattern may be performed in the above-described manner when the temperature measured by the temperature sensor is lower than a given value, and the period of time where the all-white display or the display of the starting pattern is performed may be shortened, or the all-white display or the display of the starting pattern may not be performed when the temperature measured by the temperature sensor is not less than the given value.

An illuminance sensor that measures illuminance of the surroundings may be provided in the liquid crystal display apparatuses 1 according to the first to fifth embodiments. Here, at the time of starting the backlight unit 4, the all-white display or the display of the starting pattern may be performed in the above-described manner when the illuminance measured by the illuminance sensor is lower than a given value, and the period of time where the all-white display or the display of the starting pattern is performed may be shortened, or the all-white display or the display of the starting pattern may not be performed when the illuminance measured by the illuminance sensor is not less than the given value.

The temperature sensor that measures the temperature of the backlight unit 4 may be provided in the liquid crystal display apparatuses 1 according to the first to fifth embodiments, and the control circuit 2 may be configured to store a measured value of the temperature when the non-lit detecting signal DT is output from the protection circuit 33 of the inverter power supply circuit 3 in a nonvolatile memory such as an EEPROM (Electrically Erasable and Programmable Read Only Memory) at the time of starting the backlight unit 4. This allows for analysis of the operation of the liquid crystal display apparatus 1, which could be later returned from the market as a defective.

The video signal for performing the all-white display may be produced by saturating setting of a signal processing circuit used for adjusting a black level or a gain without using the signal generation circuit 5.

The number of times of performing the all-white display and the all-black display is not limited to twice in the liquid crystal display apparatus 1 according to the fifth embodiment. The all-white display and the all-black display may be repeated any number of times. In this case, the allowable number of times of restarting the protection circuit 33 of the inverter power supply circuit 3 may be set in a changeable manner in a nonvolatile memory such as an EEPROM.

The display of the starting pattern may be performed instead of the all-white display or the all-black display in the liquid crystal display apparatus 1 according to the fifth embodiment.

When the liquid crystal display apparatus 1 is in a stand-by state (a state where only some of power supplies is turned on; for example, a state where only a tuner is turned on for downloading electronic program guide data), the all-white display may be regularly performed on the screen of the liquid crystal display panel 300 while the fluorescent lamps 40 of the backlight unit 4 are not lit. In this case, the all-white display may be performed on the screen of the liquid crystal display panel 300 only when it is detected by the illuminance sensor that the surroundings are lighted.

### (7) Correspondences between Elements in the Claims and Parts in Embodiments

In the following paragraph, non-limiting examples of correspondences between various elements recited in the claims below and those described above with respect to various preferred embodiments of the present invention are explained.

In the foregoing embodiments, the control circuit 2, the signal generation circuit 5 and the selector 6 are an example of a display controller, and the inverter power supply circuit 3 is an example of a voltage application unit.

### INDUSTRIAL APPLICABILITY

The present invention is applicable to display of video.

1. A backlight device that is provided at a liquid crystal display panel, comprising:
a fluorescent lamp arranged on a back side of said liquid crystal display panel;
a display controller that performs a starting display, whose whole or partial portion has a region that is not black, on a screen of said liquid crystal display panel for a certain period of time from the time when a power supply switch is turned on; and
a voltage application unit that applies a lighting voltage to said fluorescent lamp after a given period of time from the time when the power supply switch is turned on.

2. The backlight device according to claim 1, wherein said starting display is a display whose whole portion is white.

3. The backlight device according to claim 1, wherein said starting display is a display having a white pattern.

4. The backlight device according to claim 1, wherein said voltage application unit applies the lighting voltage to said fluorescent lamp at a given timing in a period of time where the starting display is performed by said display controller.

5. The backlight device according to claim 1, wherein said display controller performs said starting display on the screen of said liquid crystal display panel for a first period of time from the time when said power supply switch is turned on, and subsequently performs a display of black on the screen of said liquid crystal display panel for a second period of time.

6. The backlight device according to claim 1, wherein said display controller performs said starting display on the screen of said liquid crystal display panel for a first period of time from the time when said power supply switch is turned on, and subsequently performs a display having a white pattern on the screen of said liquid crystal display panel for a second period of time.

7. The backlight device according to claim 1, wherein said display controller performs said starting display and a display of black on the screen of said liquid crystal display panel from the time when said power supply switch is turned on, and subsequently repeats said starting display and said display of black a given number of times when said fluorescent lamp is not lit.

8. The backlight device according to claim 1, wherein said display controller performs said starting display and a display having a white pattern on the screen of said liquid crystal display panel from the time when said power supply switch is turned on, and subsequently repeats said starting display and said display having the white pattern a given number of times when said fluorescent lamp is not lit.

9. The backlight device according to claim 1, wherein said fluorescent lamp is an external electrode fluorescent lamp.

10. A liquid crystal display apparatus comprising:
a liquid crystal display panel; and
the backlight device according to claim 1 that is provided at said liquid crystal display panel.
